(19) United States
(12) Patent Application Publication
(10) Pub. No.: US 2008/0216750 A1
(43) Pub. Date: Sep. 11, 2008

(54) METHOD OF STIMULATING THE TEATS ...

(75) Inventor: Jan Willem SCHRADER, SPANKEREN (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: MAASLAND N.V., MAASSLUIS (NL)

(21) Appl. No.: 12/124,326

(22) Filed: May 21, 2008

Related U.S. Application Data
(63) Continuation of application No. PCT/EP2006/010785, filed on Nov. 10, 2006.

(30) Foreign Application Priority Data
Dec. 4, 2006 (NL) 1030474

(51) Int. Cl. A01J 5/007

(52) U.S. Cl. 119/14.02; 119/14.07

(57) ABSTRACT

A method of stimulating the teats of the udder of an animal comprises determining the dead milking time per udder or per quarter during a number of milkings and checking, on the basis of these historical data, whether a respective quarter has to be pre-stimulated and, if so, during what period of time. A pulsator controlled in three phases, makes it possible to adapt the suction-rest ratio of the pulsator at quarter level on the basis of the milk flow profile of the respective udder quarter.

### CROSS REFERENCE TO RELATED APPLICATIONS

This application is a continuation of International Application No. PCT/EP2006/010785 which was published under PCT Article 21(2) in English, the contents of which are hereby incorporated by reference in their entirety.

### BACKGROUND OF THE INVENTION

1. Field of the Invention

The invention relates to a method of stimulating the teats of the udder of an animal.

2. Description of the Related Art

In the known milking technique it is known per se to pre-stimulate the teats of the udder of an animal. This may take place, for example, by making the teat liner open and close relatively quickly under the influence of the pulsation vacuum at the beginning of the milking. It has been found in practice that particular cows will secrete their milk sooner than other cows. Therefore, the known state of the art has the drawback that, certainly in the case of robotized milking, with some cows there is unnecessarily spent time on pre-stimulating the udder.

### BRIEF SUMMARY OF THE INVENTION

Therefore, the present invention aims at obviating or at least reducing this drawback. According to the invention, this is achieved by determining the dead milking time per udder or per quarter during a number of milkings and by checking, on the basis of these historical data, whether a respective quarter has to be pre-stimulated and, if so, during what period of time. The dead milking time is defined here as the time elapsed between the application of a milking vacuum under the teat of a cow and the registration by a sensor of a milk flow from one or more udder quarters. By varying the pre-stimulation time at successive milkings of a relevant cow and recording at the same time the dead milking times, it is possible to determine an optimum pre-stimulation time for every cow. It is possible, for example, to start with a relatively long pre-stimulation time and to shorten it during a number of milkings, so that it is possible to determine, on the basis of these historical data, the optimum, i.e. the shortest, dead milking time which is then related with a particular pre-stimulation time. If the variation of the pre-stimulation time appears to have no influence at all on the dead milking time, it is possible that in the case of the relevant animal pre-stimulation is not necessary at all. This may be the case, for example, if a relevant animal has been treated beforehand rather intensively with cleaning brushes for cleaning the teats, because these brushes already have a stimulating effect on the milk secretion by the teats of the animal. Besides the dead milking time, a historically recorded milking rate may also form a parameter for setting the stimulation time. For this purpose, the device has to be provided with a sensor for measuring the milk flow. As also holds for the dead milking time, here it is possible to vary the pre-stimulation time during a number of milkings in order to determine in this way the optimum pre-stimulation time. It is also possible to use both parameters for determining the optimum pre-stimulation time. For the pre-stimulation, the number of pulsations will be in the range from 270 to 350 pulsations, preferably 300 pulsations, per minute. In the case that the milk flow is used as a parameter for the pre-stimulation and it is found, for example during the main milking or the stripping of a particular quarter, that the milk flow decreases against all expectations, it is possible to decide to start meantime the pre-stimulation mode during a certain period of time in order thus to reactivate the milk flow. Here it is possible to use for the main milk flow and/or the stripping particular threshold values whether or not based on historical milking profiles of previous milkings of the animal. It is also possible, for example, to decide somewhat to prolong the pre-stimulation if, for example, a particular teat has not been cleaned beforehand by means of a cleaning device, such as for example a brush.

It will be obvious that, for determining the dead milking time, it has to be taken into consideration that, when a vacuum is applied to the teat of an animal to be milked, foremilk is drawn from the teat immediately, to an amount of only a few cc, which foremilk will be secreted at all times without stimulation. This milk has to be ignored upon determination of the dead milking time.

The invention also relates to a pulsator. The pulsator may be of the type disclosed in U.S. Pat. No. 5,881,669 or as shown in US Publication No. 2004/0094096 A1, now abandoned, the contents of which are hereby incorporated by reference in their entirety. Such pulsators are usually controlled at a suction-rest ratio of 65:35, i.e. 650 milliseconds suction phase and 350 milliseconds rest phase at a pulsation frequency of 60 pulsations per minute. The invention aims to provide an alternative pulsator.

For this purpose, the pulsator is controlled in three phases for adapting a suction-rest ratio of the pulsator at quarter level on the basis of a milk flow profile of a respective udder quarter. By means of the three phase control it is possible to adapt the suction-rest ratio at quarter level on the basis of the milk flow profile of the respective udder quarter. In the milk flow profile it is possible to distinguish roughly three phases: a foremilking phase, a main milking phase and a stripping phase. In the case of three phase control, in the foremilking phase there is preferably applied a suction-rest ratio of 65:35, at a pulsation frequency of 60 pulsations per minute. When it is detected on the basis of the milk flow profile that the main milking phase has begun, the suction-rest ratio can be changed into 85:35, i.e. 850 milliseconds suction phase and 350 milliseconds rest phase. Usually the transition point from the foremilking phase to the main milking phase for a milk flow lies between approximately 0.5 kg and 1 kg per minute; this being at quarter level. The invention is based on the insight that the rest phase of 350 milliseconds is always maintained, which is necessary to guarantee a proper blood circulation of a teat. Switching from a suction-rest ratio of 65:35 to 85:35 can take place on the basis of a historical milk flow profile per quarter or on the basis of an in-line measured milk flow profile. It will be obvious that the invention is not limited to a suction-rest ratio of 85:35, but that the invention is also applicable to suction-rest ratios of e.g. 85±10%:35. The stripping will take place in the usual manner applying a suction-rest ratio of 65:35 at a pulsation frequency of 60 pulsations per minute.

The invention also relates to a method of checking the milking process on the basis of the pulsation vacuum, a method of checking the milking process on the basis of the pulsation vacuum, the method comprising: measuring the pulsation vacuum preferably per quarter, comparing the measured pulsation vacuum with a reference value, and deducing from the result of the comparison whether there are deviations that may be an indication of a defect in the pulsation circuit.

By measuring the pulsation vacuum preferably per quarter and comparing the measured value with a reference value, it is possible to check whether there are deviations that may be an indication of a defect in the pulsation circuit, such as for example a leakage or a blockage. It is then possible to record the pulsation vacuum or the pulsation vacuum curve, if desired, and to check on the basis of these historical data whether, taking possible wear into account, there are substantial deviations, i.e. abnormal deviations, that should lead, of course, to an alarm being given.

The invention is not limited to the embodiments described. The person skilled in the art will be able to apply various modifications and adaptations without departing from the spirit and scope of the invention, the scope of protection for the invention being determined by the accompanying claims.

What is claimed is:

1. A method of stimulating the teats of the udder of an animal, comprising:
determining a dead milking time of the animal during a number of milkings to acquire historical data; and
deciding for each quarter, on the basis of the historical data, whether the respective quarter has to be pre-stimulated.

2. The method of claim 1 wherein the dead milking time is determined per quarter.

3. The method of claim 2, further comprising determining, on the basis of the historical data, a length of time during which the respective quarter must be pre-stimulated.

4. A pulsator, the pulsator being controllable in three phases, for adapting a suction-rest ratio of the pulsator at quarter level on the basis of a milk flow profile of a respective udder quarter.

5. The pulsator of claim 4, wherein the pulsator provides controllable suction-rest ratios for a foremilking phase, a main milking phase and a stripping phase.

6. A method of checking the milking process on the basis of the pulsation vacuum, the method comprising:
measuring the pulsation vacuum per quarter
comparing the measured pulsation vacuum with a reference value, and
deducing from the result of the comparison whether there are deviations indicative of a defect in the pulsation circuit.

7. The method of claim 6, further comprising determining whether the deviation is an indication of a leakage in the pulsation circuit.

8. The method as claimed in claim 6, further comprising recording the pulsation vacuum to determine historical data and deducing whether there are abnormal deviations on the basis of the historical data.

9. The method as claimed in claim 6, further comprising giving an alarm.

10. The method as claimed in claim 8, further comprising giving an alarm.
